(19) United States
(12) Patent Application Publication
(10) Pub. No.: US 2019/0069251 A1
(43) Pub. Date: Feb. 28, 2019

(54) ZONE-BASED POWER CONTROL METHODS AND COMMUNICATIONS APPARATUS UTILIZING THE SAME

(71) Applicant: MEDIATEK INC., Hsin-Chu (TW)

(72) Inventors: Chih-Yuan WANG, Hsin-Chu (TW); Hong-Ching CHEN, Hsin-Chu (TW); Chih-Yu CHANG, Hsin-Chu (TW); Chih-Jung YU, Hsin-Chu (TW); Fang-Yu LIN, Hsin-Chu (TW)

(21) Appl. No.: 15/684,248

(22) Filed: Aug. 23, 2017

(51) Int. Cl. H04W 52/18

(52) U.S. Cl. CPC H04W 52/18

(57) ABSTRACT

A communications apparatus in a communications system includes a processor and a power scheme controller. The processor determines a predetermined adjustment offset for a zone according to a frame structure of the communications system. The power scheme controller is coupled to the processor, obtains information regarding the predetermined adjustment offset for the zone, determines a predetermined scaling factor for the zone, and determines a target frequency or a target voltage for the processor to operate in according to the predetermined adjustment offset and the predetermined scaling factor.

### BACKGROUND OF THE INVENTION

### Field of the Invention

The invention relates to methods for zone-based power control.

### Description of the Related Art

The term “wireless” normally refers to an electrical or electronic operation, which is accomplished without the use of a “hard wired” connection. “Wireless communications” is the transfer of information over a distance without the use of electrical conductors or wires. The distances involved may be short (a few meters for television remote controls) or very long (thousands or even millions of kilometers for radio communications). The best known example of wireless communications is the cellular telephone. Cellular telephones use radio waves to enable an operator to make phone calls to another party from many locations worldwide. They can be used anywhere, as long as there is a cellular telephone site to house equipment that can transmit and receive signals, which are processed to transfer both voice and data to and from the cellular telephones.

There are various well-developed and well-defined cellular communications technologies. For example, the Global System for Mobile communications (GSM) is a well-defined and commonly used communications system, which uses time division multiple access (TDMA) technology, which is a multiplex access scheme for digital radio, to send voice, data, and signaling data (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Wireless Fidelity (Wi-Fi) is a technology defined by the 802.11 engineering standard and can be used for home networks, mobile phones, video games, to provide a high-frequency wireless local area network. The Long-Term Evolution (LTE) is a standard for wireless communication of high-speed data for mobile phones and data terminals. It is based on the GSM/EDGEand UMTS/HSPA network technologies, increasing the capacity and speed using a different radio interface together with core network improvements.

In order to provide more efficient communications services, methods for efficient wireless communications are provided.

### BRIEF SUMMARY OF THE INVENTION

A zone-based power control method and communications apparatuses are provided. An exemplary embodiment of a communications apparatus in a communications system comprises a processor and a power scheme controller. The processor determines a predetermined adjustment offset for a zone according to the frame structure of the communications system. The power scheme controller is coupled to the processor, obtains information regarding the predetermined adjustment offset for the zone, determines a predetermined scaling factor for the zone, and determines a target frequency or a target voltage for the processor to operate in according to the predetermined adjustment offset and the predetermined scaling factor

An exemplary embodiment of a zone-based power control method executed by a communications apparatus in a communications system comprises: determining a predetermined adjustment offset for a zone according to the frame structure of the communications system; determining a predetermined scaling factor for the zone; and determining a target frequency or a target voltage for the communications apparatus to operate in according to the predetermined adjustment offset and the predetermined scaling factor.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A shows an exemplary block diagram of a communications apparatus according to an embodiment of the invention;

FIG. 1B shows an exemplary block diagram of a communications apparatus according to another embodiment of the invention;

FIG. 2 shows an exemplary block diagram of a modem according to an embodiment of the invention;

FIG. 3 is an exemplary flow chart showing a proposed zone-based power control method executed by a communications apparatus in a communications system according to an embodiment of the invention;

FIG. 4 is a schematic block diagram showing the devices in the communications apparatus to perform the proposed control schemes according to an embodiment of the invention;

FIG. 5 is another exemplary flow chart showing a proposed zone-based power control method according to another embodiment of the invention;

FIG. 6A is a schematic diagram showing the frequency adjustment result of the proposed zone-based power control scheme according to an embodiment of the invention;

FIG. 6B is a schematic diagram showing the frequency and voltage adjustment results of the proposed zone-based power control scheme according to another embodiment of the invention;

FIG. 7A is a schematic showing the operation frequency without applying the zone-based power control scheme;

FIG. 7B is a schematic showing the operation frequency after applying the zone-based power control scheme according to an embodiment of the invention;

FIG. 8A is a schematic showing the operation frequency after applying the static control scheme according to an embodiment of the invention; and

FIG. 8B is a schematic showing the operation frequency after applying the dynamic control scheme according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

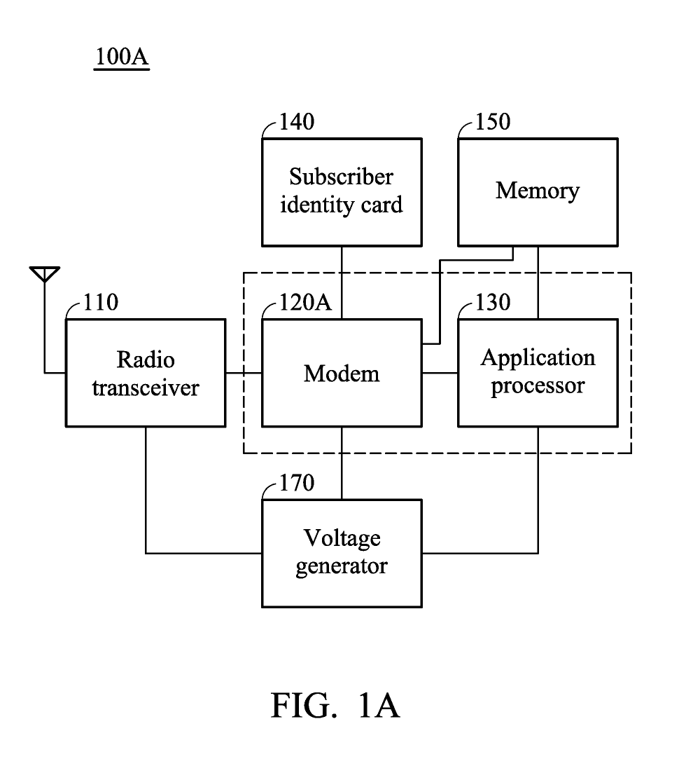

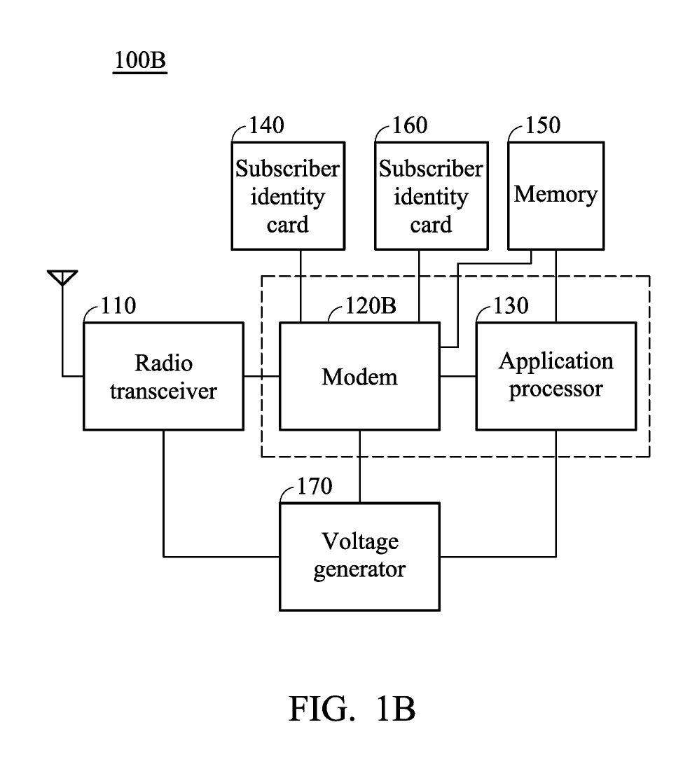

FIG. 1A shows an exemplary block diagram of a communications apparatus according to an embodiment of the invention. The communications apparatus 100A may be a portable electronic device, such as a Mobile Station (MS, which may be interchangeably referred to as User Equipment (UE)). The communications apparatus 100A may comprise at least an antenna module comprising at least one antenna, a radio transceiver 110, a modem 120A, an application processor 130, a subscriber identity card 140, a memory 150, and a voltage generator. The radio transceiver 110 may receive wireless radio frequency signals via the antenna module, transmit wireless radio frequency signals via the antenna module and perform RF signal processing. For example, the radio transceiver 110 may convert the received signals to intermediate frequency (IF) or baseband signals to be processed, or receive the IF or baseband signals from the modem 120A and convert the received signals to wireless radio frequency signals to be transmitted to a network device. According to an embodiment of the invention, the network device may be a cell, an evolved node B, a base station, a Mobility Management Entity (MME) etc., at the network side and communicating with the communications apparatus 100A via the wireless radio frequency signals.

The radio transceiver 110 may comprise a plurality of hardware devices to perform radio frequency conversion and RF signal processing. For example, the radio transceiver 110 may comprise a power amplifier for amplifying the RF signals, a filter for filtering unwanted portion in the RF signals and/or a mixer for performing radio frequency conversion. According to an embodiment of the invention, the radio frequency may be, for example, 900 MHz or 1800 MHz for a Global System for Mobile communication (GSM), or 1900 MHz for a Universal Mobile Telecommunications System (UMTS), or the frequency of any specific frequency band for a Long-Term Evolution (LTE) system, etc.

The modem 120A may be a cellular communications modem configured for handling cellular system communications protocol operations and processing the IF or baseband signals received from or to be transmitted to the radio transceiver 110. The application processor 130 is configured for running the operating system of the communications apparatus 100A and running application programs installed in the communications apparatus 100A. In the embodiments of the invention, the modem 120A and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an International Mobile Subscriber Identity (IMSI) and a set of SIM application toolkit (SAT) commands and may provide storage space for phone book contacts. The memory 150 may be coupled to the modem 120A and application processor 130 and may store system data or user data. The voltage generator 170 may be coupled to the modem 120A, the application processor 130 and the radio transceiver 110 for providing operation voltage thereto. According to an embodiment of the invention, the voltage generator 170 may, for example, be a power management IC configured outside of the modem 120A and the application processor 130. This configuration is presented as an example, and the invention is not limited thereto.

FIG. 1A shows a single-card single-standby application. With advancements in communications techniques, communications apparatuses are now capable of supporting multi-card multi-standby application and handling multi-RAT (radio access technology) operations, such as at least two of GSM/GPRS/EDGE (Global System for Mobile Communications/General Packet Radio Service/Enhanced Data rates for Global Evolution), WCDMA (Wideband Code Division Multiple Access), cdma2000, WiMAX (Worldwide Interoperability for Microwave Access), TD-SCDMA (Time Division Synchronous Code Division Multiple Access), LTE (Long Term Evolution), and TD-LTE (Time Division Long Term Evolution) RATs, or the like via one communications apparatus.

FIG. 1B shows an exemplary block diagram of a communications apparatus according to another embodiment of the invention. Most of the elements shown in FIG. 1B are similar to FIG. 1A, and thus the descriptions are omitted here for brevity. In this embodiment, the communications apparatus 100B may comprise multiple subscriber identity cards 140 and 160 coupled to the modem 120B, thereby the modem 120B may at least support two RATs communications, wherein the two RATs may be different RATs or the same RAT, and the invention should not be limited to either case.

According to an embodiment of the invention, the modem 120B, the radio transceiver 110 and/or the antenna module may be shared by subscriber identity cards 140 and 160 to support at least two RATs communications. Therefore, in this embodiment, the communications apparatus 100B may be regarded as comprising at least two communications units, one may at least comprise the subscriber identity card 140, (all or part of) the modem 120B, the radio transceiver 110 and the antenna module, and another one may at least comprise the subscriber identity card 160, (all or part of) the modem 120B, the radio transceiver 110 and the antenna module.

According to an embodiment of the invention, the modem 120B may have the capability of handling the operations of multiple cellular system communications protocols and processing the IF or baseband signals for the corresponding communications units. Each communications unit may operate independently at the same time in compliance with a corresponding communications protocol, and thereby the communications apparatus 100B can support a multi-card multi-standby application.

Note that, in order to clarify the concept of the invention, FIG. 1A and FIG. 1B represent simplified block diagrams in which only the elements relevant to the invention are shown. For example, in some embodiments of the invention, the communications apparatus may further comprise some peripheral devices not shown in FIG. 1A and FIG. 1B. In another example, in some embodiments of the invention, the communications apparatus may further comprise a central controller coupled to the modem 120A/120B and the application processor 130. Therefore, the invention should not be limited to what is shown in FIG. 1A and FIG. 1B.

Note further that subscriber identity cards 140 and 160 may be dedicated hardware cards as described above, or in some embodiments of the invention, there may be individual identifiers, numbers, addresses, or the like which are burned in the internal memory device of the corresponding modem and are capable of identifying the individual communications entity that the corresponding communications unit operates. Therefore, the invention should not be limited to what is shown in the figures.

Note further that although communications apparatuses 100B shown in FIG. 1B support two RAT wireless communications services, the invention should not be limited thereto. Those who are skilled in this technology can still make various alterations and modifications based on the descriptions given above to derive the communications apparatuses capable of supporting more than two RAT wireless communications without departing from the scope and spirit of this invention.

Note further that, although in FIG. 1B, the radio transceiver 110 and the antenna module are shared by multiple communications units, the invention should not be limited thereto. Those who are skilled in this technology can still make various alterations and modifications based on the descriptions given above to derive the communications apparatuses comprising multiple radio transceivers and/or multiple antenna modules for supporting multiple RAT wireless communications without departing from the scope and spirit of this invention.

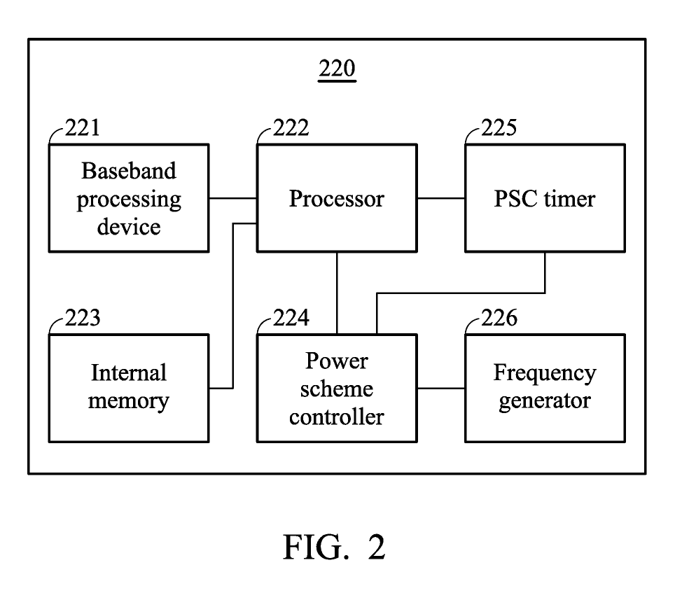

FIG. 2 shows an exemplary block diagram of a modem according to an embodiment of the invention. The modem 220 may be the modem 120A or 120B shown in FIG. 1A and FIG. 1B and may comprise at least a baseband processing device 221, a processor 222, an internal memory 223, a power scheme controller (PSC) 224, a PSC Timer 225 and a frequency generator 226. The baseband processing device 221 may receive the IF or baseband signals from the radio transceiver 110 and perform IF or baseband signal processing. For example, the baseband processing device 221 may convert the IF or baseband signals to a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, a encoder for signal encoding, a decoder for signal decoding, and so on.

The processor 222 may control the operations of the modem 220. According to an embodiment of the invention, the processor 222 may be arranged to execute the program codes of the corresponding software module of the modem 220. The processor 222 may maintain and execute the individual tasks, threads, and/or protocol stacks for different software modules. In a preferred embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may also read data from the subscriber identity card coupled to the modem, such as the subscriber identity card 140 and/or 160, and write data to the subscriber identity card. The internal memory 223 may store system data and user data for the modem 220. The processor 222 may also access the internal memory 223.

The PSC 224 provides power control for the communications apparatus. According to an embodiment of the invention, the PSC 224 may obtain information regarding the timing records Az (or, the difference between different timing records) from the PSC timer 225 and other parameters (which will be discussed in more detail in the following paragraphs) from the processor 222, calculate a timing error Te based on the timing records Az and/or the parameters, and determine the target frequency Ftarget and/or target voltage Vtarget for the processor 222 to operate in, so as to control the operation speed and the power consumption, and achieve an optimum balance therebetween. Operations of the proposed control schemes will be discussed in more detail in the following paragraphs.

The PSC timer 225 may offer current timing record when being triggered by any device or circuit of the communications apparatus (e.g. the communications apparatus 100A, 100B or the like), and assist in calculating the difference between different time records. Note that in some embodiment of the invention, the PSC timer 225 may be comprised in or just a part of the PSC 224, or may be a general purpose hardware. Therefore, the invention should not be limited to any specific implementation method. Note further that, in some embodiment of the invention, an internal timer of the processor 222 may also be implemented to provide the functions of offering current timing record and/or assisting in calculating the difference between different time records. Therefore, the invention should not be limited to any specific implementation method.

Note further that, in order to clarify the concept of the invention, FIG. 2 represents simplified block diagrams in which only the elements relevant to the invention are shown. Therefore, the invention should not be limited to what is shown in FIG. 2.

Note further that in some embodiments of the invention, the modem may comprise more than one processor and/or more than one baseband processing device. For example, the modem may comprise multiple processors and/or multiple baseband processing devices for supporting multi-RAT operations. Therefore, the invention should not be limited to what is shown in FIG. 2.

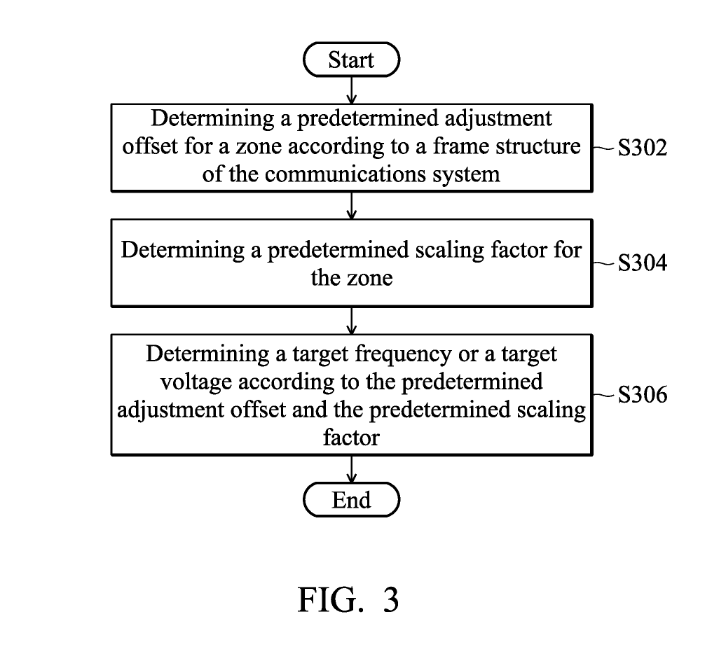

FIG. 3 is an exemplary flow chart showing a proposed zone-based power control method executed by a communications apparatus (e.g. the communications apparatus 100A, 100B or the like) in a communications system according to an embodiment of the invention. First of all, one or more zones may be defined. According to an embodiment of the invention, a zone may be a frame, a sub-frame, a slot, a symbol or a channel defined by the communications system. According to another embodiment of the invention, a zone may also be defined as more than one frame, more than one sub-frame, more than one slot, more than one symbol or more than one channel. In the embodiments, the communications system may be the LTE communications system, the LTE-Advanced communications system, the LTE-related system communications system, or any further advanced communications system with a well-defined frame (also, sub-frame, slot, symbol, channel, or the like) structure.

Note that, in the embodiments of the invention, the proposed zone-based power control methods may be applied in multiple zones with the same or different lengths or durations. Therefore, the invention should not be limited to any specific implementation methods.

In the proposed zone-based power control method, a predetermined adjustment offset for a zone is determined according to the frame structure of the communications system (Step S302) and a predetermined scaling factor for the zone is also determined (Step S304). Next, a target frequency or a target voltage for the communications apparatus to operate in is determined according to the predetermined adjustment offset and the predetermined scaling factor (Step S306).

In a preferred embodiment of the invention, there may be one or more predetermined adjustment offset determined for each zone, and one or more predetermined scaling factor determined for each zone. However, the invention is not limited to any specific implementation method.

FIG. 3 shows a static control scheme. In another embodiment of the invention, a dynamic control scheme is proposed. In the dynamic control scheme, the actual execution duration for executing the task in the zone may be recoded. A timing error may be calculated according to the actual execution duration. The target frequency or the target voltage for the communications apparatus to operate in may be determined further according to the timing error.

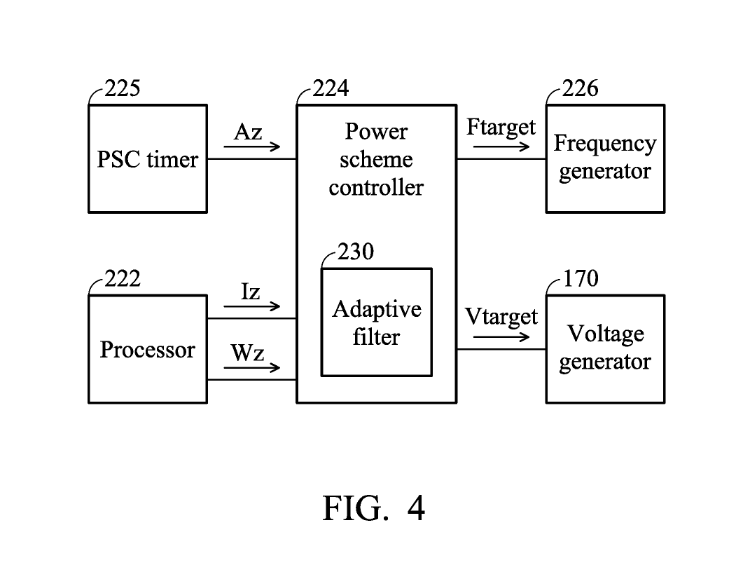

FIG. 4 is a schematic block diagram showing the devices in the communications apparatus (e.g. the communications apparatus 100A, 100B or the like) to perform the proposed control schemes according to an embodiment of the invention. According to an embodiment of the invention, the processor 222 may determine the predetermined adjustment offset Wz for a zone according to the frame structure of the communications system, and provide information regarding the predetermined adjustment offset Wz to the power scheme controller 224.

The power scheme controller 224 may also determine the predetermined scaling factor Kz for the zone, and determine the target frequency Ftarget or target voltage Vtarget for the processor 222 to operate in according to the predetermined adjustment offset Wz and the predetermined scaling factor Kz. Information regarding the target frequency Ftarget may be provided to the frequency generator 226 for the frequency generator 226 to generate the operation frequency of the processor 222 according to the target frequency Ftarget. Information regarding the target voltage Vtarget may be provided to the voltage generator 170 for the voltage generator 170 to generate the operation voltage of the processor 222 according to the target voltage Vtarget.

In an embodiment of the invention, the processor 222 may determine the frequency requirement of the zone according to the frame structure, and determine the predetermined adjustment offset Wz according to the frequency requirement. The frequency requirement may be related to the required operation frequency for the processor 222 to operate in, so as to complete a task that is assigned to be executed in that zone. In a preferred embodiment, the required operation frequency should be high enough for the processor 222 to operate at a high enough speed to complete the task on time (that is, the task can be finished no later than the time at which it should be finished).

In another embodiment of the invention, the processor 222 may determine the loading of the zone according to the frame structure, determine the frequency requirement according to the loading, and determine the predetermined adjustment offset Wz according to the frequency requirement. In the embodiments of the invention, the loading may be related to the amount of data for the processor to process (including transmitting, receiving, signal processing, and other tasks).

In yet another embodiment of the invention, the processor 222 may determine the voltage requirement of the zone according to the loading, as discussed above, or the frame structure, and determine the predetermined adjustment offset Wz according to the voltage requirement. The voltage requirement may be related to the required operation voltage for the processor 222 to operate on, so as to complete a task that is assigned to be executed in that zone. In a preferred embodiment, the required operation voltage should be high enough for the processor 222 to have enough power to operate at a high enough speed to complete the task on time (that is, the task can be finished no later than the time at which it should be finished).

In the embodiments of the invention, the frame (also, sub-frame, slot, symbol, channel, or the like) structure may comprise the uplink/downlink scheduling, channel scheduling, guard period reservation, and others.

Note that, because there may be some unexpected jobs/tasks, such as high priority jobs/tasks, that could interrupt the execution of a current task, in the embodiments of the invention, besides the predetermined adjustment offset Wz, the predetermined scaling factor Kz is also introduced to scale the frequency or voltage, so as to generate some margin for the target frequency Ftarget or the target voltage Vtarget to be high enough to handle the unexpected jobs/tasks.

The PSC Timer 225 may record and provide the timing records Az. For example, the PSC Timer 225 may record a counter value counted by a counter (not shown) when the execution of a task in a zone begins as the start time for the execution the task, and further record the counter value when the execution of the task in the zone ends as the end time, and provide the start time and end time timing records for the PSC 224 to derive the actual execution duration, or the difference between the end time and the start time as the actual execution duration. The PSC Timer 225 may provide information regarding the timing records Az (which may include the difference between different timing records) to the power scheme controller 224.

The processor 222 may also estimate an ideal execution duration Iz for executing the task in the zone according to the frame structure, the loading, the frequency requirement and/or the voltage requirement as discussed above, and provide information regarding the ideal execution duration Iz to the power scheme controller 224.

The power scheme controller 224 may further derive a duration error Dz for a zone according to the actual execution duration and the ideal execution duration Iz. For example, the duration error Dz may be derived by the difference between the ideal execution duration Iz and the actual execution duration. For another example, the duration error Dz may be derived as Dz=(actual execution duration−ideal execution duration Iz). According to an embodiment of the invention, the power scheme controller 224 may comprise an adaptive filter (which may be either a hardware device or a software module) 230 to adaptively adjust the predetermined scaling factor Kz according to the duration error Dz. For example, the adaptive filter 230 may learn the duration error Dz corresponding to a specific task and adaptively adjust the predetermined scaling factor Kz, for the duration error Dz corresponding to the specific task to converge and approach zero or converge to a value that is small enough. Note that in some embodiments of the invention, the power scheme controller 224 may be an adaptive filter to adaptively adjust the predetermined scaling factor Kz according to the duration error Dz.

Since the power control schemes are zone-based approaches, information regarding a specific task or a specific zone may be recorded with the predetermined scaling factor Kz thereof. In this manner, the adjusted predetermined scaling factor Kz corresponding to the specific task may be applied in any subsequent zone, or may be applied in a specific zone in which the processor 222 is going to execute the same or a similar task.

Besides adaptively adjusting the predetermined scaling factor Kz, the power scheme controller 224 may also determine the target frequency Ftarget or the target voltage Vtarget in a dynamic approach further according to the duration error Dz. Similarly, the determined target frequency Ftarget or the target voltage Vtarget may be applied in any subsequent zone, or may be applied in a specific zone in which the processor 222 is going to execute the same task or a similar one.

In an embodiment of a static control scheme, the power scheme controller 224 may derive a timing error Te as Te=Wz*Kz, and determine the target frequency Ftarget or the target voltage Vtarget according to the timing error Te. For example, although the invention is not limited to this example, when a value of the timing error Te is positive, the power scheme controller 224 may determine the size of the increment of the operation frequency or operation voltage according to the timing error Te, and/or increase a current operation frequency or a current operation voltage by the corresponding increment thereof, so as to determine the value of the target frequency Ftarget or the target voltage Vtarget. On the other hand, when the timing error Te is negative, the power scheme controller 224 may determine the size of the decrement of the operation frequency or operation voltage according to the timing error Te, and/or decrease a current operation frequency or a current operation voltage by the corresponding decrement thereof, so as to determine the value of the target frequency Ftarget or the target voltage Vtarget.

In an embodiment of a dynamic control scheme, the power scheme controller 224 may derive a timing error Te as Te=(Dz+Wz)*Kz, and determine the target frequency Ftarget or the target voltage Vtarget according to the timing error Te. For example, although the invention is not limited to this example, when the value of the timing error Te is positive, the power scheme controller 224 may determine the size of the increment of the operation frequency or operation voltage according to the timing error Te, and/or increase a current operation frequency or a current operation voltage by the corresponding increment thereof, so as to determine the value of the target frequency Ftarget or the target voltage Vtarget. On the other hand, when the timing error Te is negative, the power scheme controller 224 may determine the size of the decrement of the operation frequency or operation voltage according to the timing error Te, and/or decrease a current operation frequency or a current operation voltage by the corresponding decrement thereof, so as to determine the value of the target frequency Ftarget or the target voltage Vtarget.

Note that a maximum value and a minimum value of the operation frequency and the operation voltage may be predefined by the processor 222 or the power scheme controller 224 to protect the devices in the communications apparatus. Therefore, the operation frequency and the operation voltage will be kept in a range between the maximum value and the minimum value, so that the corresponding devices do not break down.

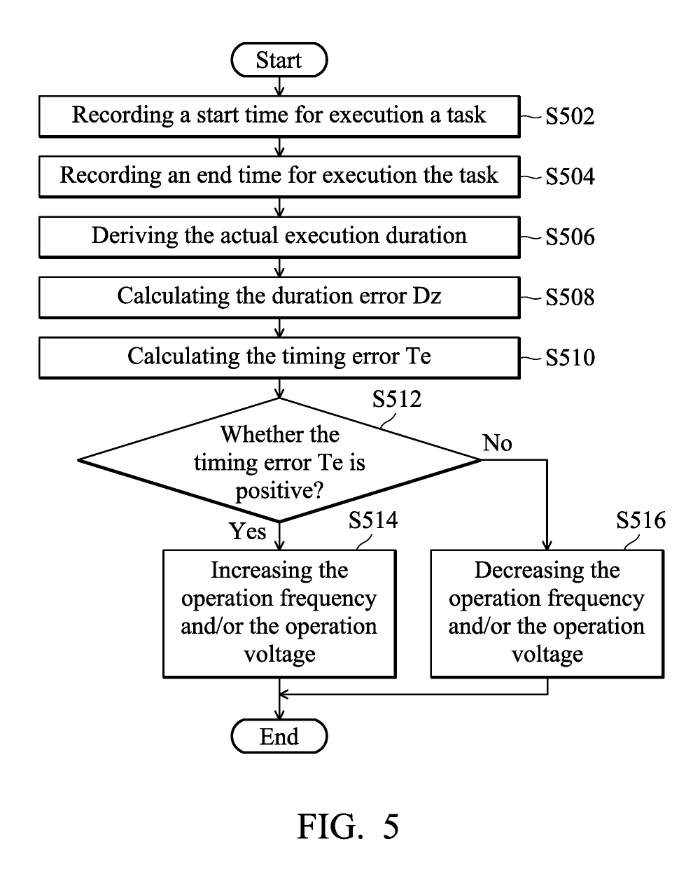

FIG. 5 is another exemplary flow chart showing a proposed zone-based power control method according to another embodiment of the invention. The start time for executing a task in a zone is first recorded (Step S502). Next, the end time for the execution of the task is also recorded (Step S504). Next, the actual execution duration may be derived according to recorded the start time and end time timing records Az (Step S506). Next, a duration error Dz may be calculated according to the actual execution duration and the ideal execution duration Iz (Step S508). Note that, in some embodiments of the invention, the predetermined scaling factor Kz for the zone may also be calculated or adjusted according to the duration error Dz in step S508. Next, the timing error Te is calculated (Step S510) based on either the static control scheme or the dynamic control scheme as discussed above. Next, whether the timing error Te is positive is determined (Step S512). If so, it means that the current operating frequency/voltage may be not high enough, resulting in that the actual execution duration is longer than the corresponding zone duration. In this manner, the power scheme controller 224 may determine to increase the operation frequency and/or the operation voltage (Step S514). If the timing error Te is negative, it means that the current operating frequency/voltage may be too high, resulting in that the actual operation speed is fast and the task assigned in that zone is finished earlier. In this manner, the power scheme controller 224 may determine to decrease the operation frequency and/or the operation voltage (Step S516).

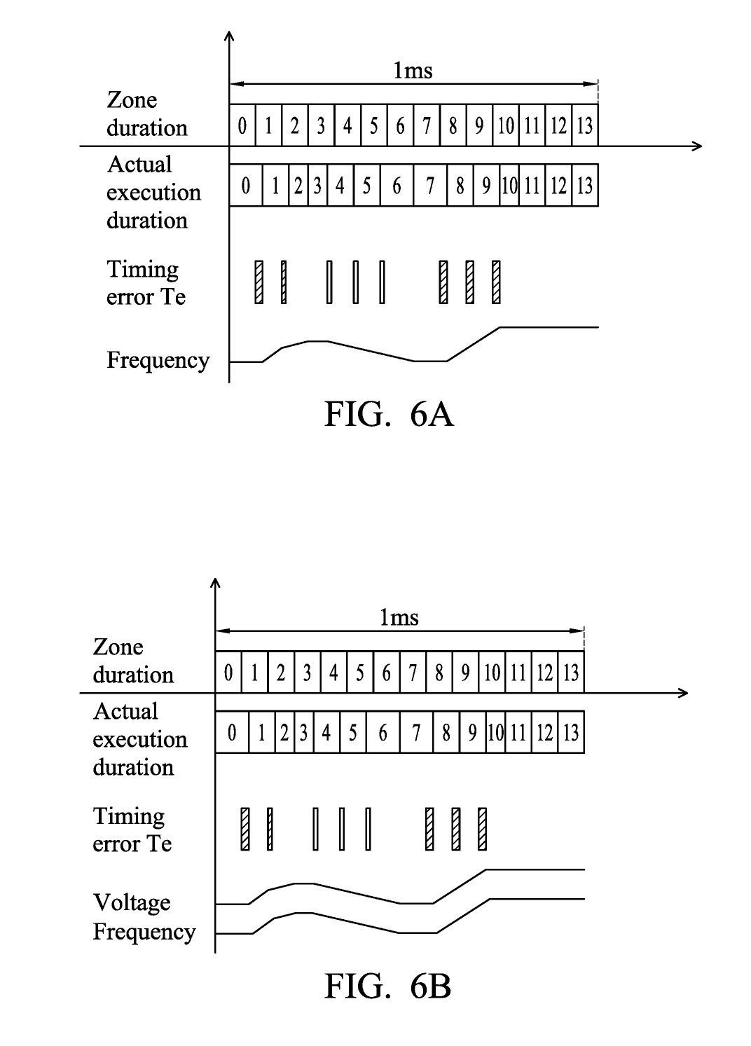

FIG. 6A is a schematic diagram showing the frequency adjustment result of the proposed zone-based power control scheme according to an embodiment of the invention. FIG. 6B is a schematic diagram showing the frequency and voltage adjustment results of the proposed zone-based power control scheme according to another embodiment of the invention. In the embodiments shown in FIG. 6A and FIG. 6B, a zone is defined as one OFDM symbol with normal Cyclic Prefix (CP), where a subframe (1 ms) comprises 14 symbols as shown.

As shown in FIG. 6A and FIG. 6B, when the actual execution duration exceeds the corresponding zone duration, the timing error Te is positive (shown as rectangles with slashes), which means that the current operating frequency/voltage may be not high enough for the actual operation speed being too slow. In this manner, the operation frequency and/or voltage should be increased, so as to speed up the execution. When the actual execution duration is shorter than the corresponding zone duration, this means that the current operating frequency/voltage may be too high for the actual operation speed being too fast. In this manner, the operation frequency and/or voltage should be decreased, so as to slow down the execution and decrease the power consumption. Note that, in the embodiments of the invention, the adjustment of operation voltage takes place earlier than the adjustment of operation frequency when operation frequency is increasing and the adjustment of operation frequency takes place earlier than the adjustment of operation voltage when operation frequency is decreasing, as shown in FIG. 6B.

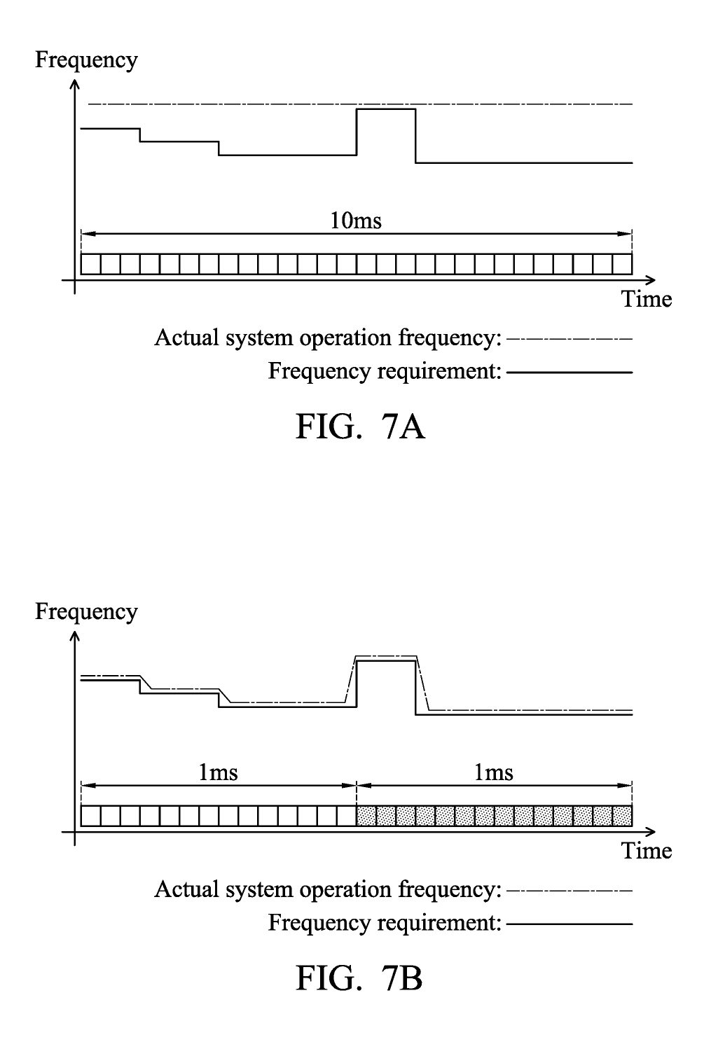

FIG. 7A is a schematic showing the operation frequency without applying the zone-based power control scheme. FIG. 7B is a schematic showing the operation frequency after applying the zone-based power control scheme according to an embodiment of the invention. As shown in FIG. 7A, since the tasks to be performed may vary over time, the frequency requirements may vary over time as well. When the actual system operation frequency is fixed, sometimes undesired power consumption may be generated when the operation frequency is too high and sometimes latency may occur when the operation frequency is too low.

As shown in FIG. 7B, by applying the zone-based power control scheme, the actual system operation frequency can meet the frequency requirements. In this manner, the undesired power consumption and latency can be avoided. In other words, an optimum balance between the operation speed and the power consumption can be achieved. In the embodiment shown in FIG. 7B, a zone is defined as three OFDM symbols.

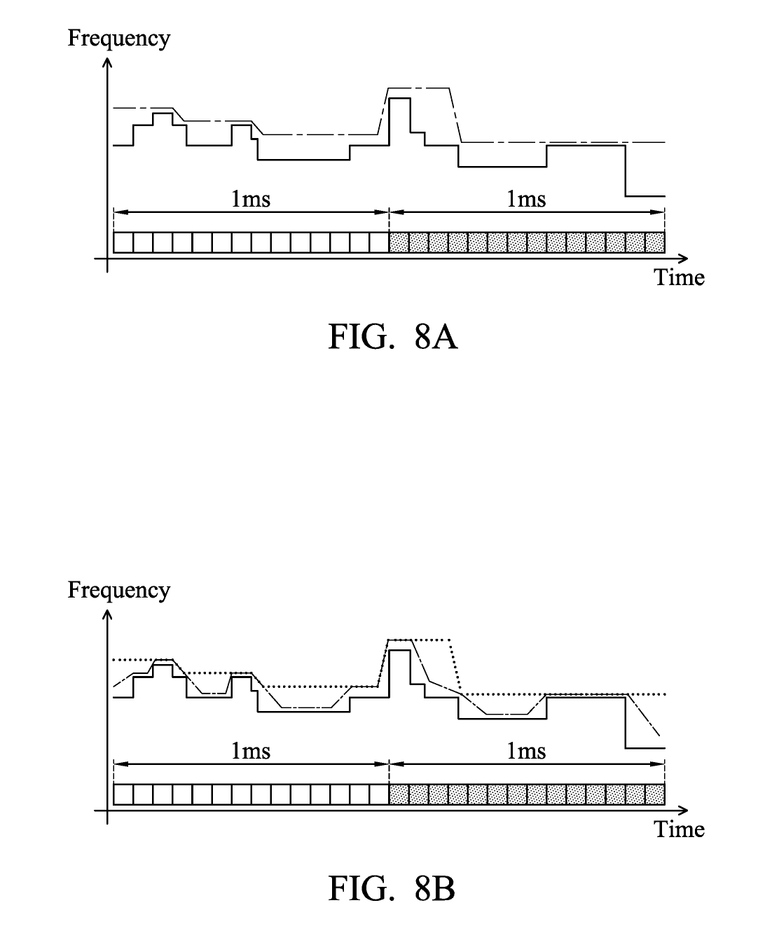

FIG. 8A is a schematic showing the operation frequency after applying the static control scheme according to an embodiment of the invention. FIG. 8B is a schematic showing the operation frequency after applying the dynamic control scheme according to an embodiment of the invention. In the embodiment shown in FIG. 8A and FIG. 8B, a zone is defined as three OFDM symbols.

Comparing FIG. 8A and FIG. 8B, the power consumption can be improved further. Therefore, the power control performance can be enhanced further when applying the dynamic control scheme.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus in a communications system, comprising:
a processor, determining a predetermined adjustment offset for a zone according to a frame structure of the communications system; and
a power scheme controller, coupled to the processor, obtaining information regarding the predetermined adjustment offset for the zone, determining a predetermined scaling factor for the zone, and determining a target frequency or a target voltage for the processor to operate in according to the predetermined adjustment offset and the predetermined scaling factor.

2. The communications apparatus as claimed in claim 1, wherein the zone is a frame, a sub-frame, a slot, a symbol or a channel defined by the communications system.

3. The communications apparatus as claimed in claim 1, wherein the processor further estimates an ideal execution duration for executing a task in the zone, and the power scheme controller further obtains information regarding the ideal execution duration and information regarding an actual execution duration for executing the task in the zone, calculates a duration error according to the actual execution duration and the ideal execution duration and determines the target frequency or the target voltage further according to the duration error.

4. The communications apparatus as claimed in claim 3, wherein the power scheme controller comprises an adaptive filter adaptively adjusting the predetermined scaling factor according to the duration error.

5. The communications apparatus as claimed in claim 1, wherein the processor and determines the predetermined adjustment offset according to the frequency requirement.

6. The communications apparatus as claimed in claim 1, wherein the processor determines a predetermined adjustment offset for each zone, and the power scheme controller determines a predetermined scaling factor for each zone.

7. The communications apparatus as claimed in claim 1, wherein the power scheme controller derives a timing error Te according to a multiplication of the predetermined adjustment offset and the predetermined scaling factor, and determines the target frequency or the target voltage according to the timing error Te.

8. The communications apparatus as claimed in claim 3, wherein the power scheme controller derives a timing error Te according to a summation of the duration error and the predetermined adjustment offset, and a multiplication of the summation and the predetermined scaling factor, and determines the target frequency or the target voltage according to the timing error Te.

9. The communications apparatus as claimed in claim 7, wherein when the timing error is positive, the power scheme controller increases a current operation frequency or a current operation voltage according to the timing error, and when the timing error is negative, the power scheme controller decreases a current operation frequency or a current operation voltage according to the timing error.

10. The communications apparatus as claimed in claim 8, wherein when the timing error is positive, the power scheme controller increases a current operation frequency or a current operation voltage according to the timing error, and when the timing error is negative, the power scheme controller decreases a current operation frequency or a current operation voltage according to the timing error.

11. A zone-based power control method executed by a communications apparatus in a communications system, comprising:
determining a predetermined adjustment offset for a zone according to a frame structure of the communications system;
determining a predetermined scaling factor for the zone; and
determining a target frequency or a target voltage for the communications apparatus to operate in according to the predetermined adjustment offset and the predetermined scaling factor.

12. The method as claimed in claim 11, wherein the zone is a frame, a sub-frame, a slot, a symbol, or a channel defined by the communications system.

13. The method as claimed in claim 11, further comprising:
estimating an ideal execution duration for executing a task in the zone;
recording an actual execution duration for executing the task in the zone;
calculating a duration error according to the actual execution duration and the ideal execution duration; and
determining the target frequency or the target voltage further according to the duration error.

14. The method as claimed in claim 13, further comprising:
adaptively adjusting the predetermined scaling factor according to the duration error.

15. The method as claimed in claim 11, wherein the step of determining the predetermined adjustment offset further comprises:
determining a frequency requirement of the zone according to the frame structure; and
determining the predetermined adjustment offset according to the frequency requirement.

16. The method as claimed in claim 11, further comprising:
determining a predetermined adjustment offset and a predetermined scaling factor for each zone.

17. The method as claimed in claim 11, further comprising:
deriving a timing error Te according to a multiplication of the predetermined adjustment offset and the predetermined scaling factor; and
determining the target frequency or the target voltage according to the timing error Te.

18. The method as claimed in claim 13, further comprising:
deriving a timing error Te according to a summation of the duration error and the predetermined adjustment offset, and a multiplication of the summation and the predetermined scaling factor; and
determining the target frequency or the target voltage according to the timing error Te.

19. The method as claimed in claim 17, wherein the step of determining the target frequency or the target voltage comprises:
when the timing error is positive, determining to increase a current operation frequency or a current operation voltage according to the timing error; and
when the timing error is negative, determining to decrease a current operation frequency or a current operation voltage according to the timing error.

20. The method as claimed in claim 18, wherein the step of determining the target frequency or the target voltage comprises:
when the timing error is positive, determining to increase a current operation frequency or a current operation voltage according to the timing error; and
when the timing error is negative, determining to decrease a current operation frequency or a current operation voltage according to the timing error.
